(19) United States
(12) Patent Application Publication
(10) Pub. No.: US 2026/0326470 A1
(43) Pub. Date: Oct. 22, 2026

(54) LIGHT STABLE DIRECT THERMAL IMAGING SYSTEM

(71) Applicant: Appvion, LLC, Appleton, WI (US)

(72) Inventors: Mark R. Fisher, Appleton, WI (US); Nicholas J. Sortedahl, Appleton, WI (US)

(73) Assignee: Appvion, LLC, Appleton, WI (US)

(21) Appl. No.: 19/646,828

(22) Filed: Apr. 14, 2026

Related U.S. Application Data
(60) Provisional application No. 63/788,453, filed on Apr. 14, 2025.

(51) Int. Cl. B41M 5/44; B41M 5/323

(52) U.S. Cl. CPC B41M 5/44; B41M 5/323; B41M 2205/40

(57) ABSTRACT

A recording medium has an imaging layer, an oxygen barrier layer, and a topcoat. The imaging layer has a first facial surface and a second facial surface. The oxygen barrier layer also has a first facial surface and a second facial surface. The first facial surface of the oxygen barrier layer is in direct contact with the second facial surface of the imaging layer. The oxygen barrier layer comprises a polyvinyl alcohol. The topcoat layer is in direct or indirect contact with the first facial surface of the imaging layer.

### CROSS-REFERENCE TO RELATED APPLICATIONS

This application claims the benefit of U.S. Provisional Application No. 63/788,453, filed Apr. 14, 2025, and titled LIGHT STABLE DIRECT THERMAL IMAGING SYSTEM.

### FIELD OF THE INVENTION

The present disclosure relates to an oxygen barrier layer for a recording medium, and more particularly to a recording medium comprising an oxygen barrier layer in direct contact with an imaging layer and related methods.

### BACKGROUND

One problem with conventional direct thermal recording medium has been fade of the image. Upon exposure to light the printed image changes from a black image to a brown image. Images fade more quickly in sunlight, which prevent direct thermal recording medium from being used in outdoor applications as well as long-term indoor applications. The change from black to brown also reduces the intensity of the image and therefore the contrast between the light and dark areas of the image.

The reduced contrast is a particular problem when the image is a barcode. The reduction can affect the ability of a scanner to read a barcode. Direct thermal recording medium is therefore not suited for barcodes to be used in situations where they would be exposed to significant light, such as in greenhouse applications, or stored for long periods of time, such as in warehouse.

Attempts have been made to reduce image fade by using UV absorbers in the recording medium or modifying the leuco dye to achieve improvements in image stability. Such attempts have achieved limited success and the images show limited improvements in stability over time. These solutions are also costly. Some compounds that have been used, such as benzophenones and benzotriazoles, also pose risks to the environment.

Accordingly, it would be desirable to utilize existing direct thermal recording medium with improved image retention that do not rely on UV absorbers, blockers, or light scattering particles. More specifically, it would be desirable to provide a direct thermal recording medium with improved image retention, particularly when exposed to light and/or stored for long periods of time, that do not rely on UV absorbers, blockers, or light scattering particles.

### BRIEF SUMMARY

A recording medium is disclosed herein. In accordance with embodiments of the present disclosure, a recording medium comprises an imaging layer having a first facial surface and a second facial surface, an oxygen barrier layer having a first facial surface and a second facial surface, and a topcoat layer in direct or indirect contact with the first facial surface of the imaging layer. The first facial surface of the oxygen barrier layer is in direct contact with the second facial surface of the imaging layer. The oxygen barrier layer comprises a polyvinyl alcohol.

In an embodiment, the oxygen barrier layer comprises from greater than or equal to 30 wt % to less than or equal to 100 wt % of the polyvinyl alcohol. In a further embodiment, the oxygen barrier layer comprises from greater than or equal to 60 wt % to less than or equal to 95 wt % of the polyvinyl alcohol. In another embodiment, the oxygen barrier layer comprises from greater than or equal to 30 wt % to less than or equal to 75 wt % of the polyvinyl alcohol.

In embodiments, the polyvinyl alcohol has a viscosity greater than 10 cP. In some embodiments, the polyvinyl alcohol has a viscosity from greater than or equal to 20 cP to 140 cP.

In embodiments, the polyvinyl alcohol has a molecular weight from 85,000 Da to 320,000 Da.

In an embodiment, the polyvinyl alcohol is a modified polyvinyl alcohol. In a further embodiment, the modified polyvinyl alcohol is a carboxylated polyvinyl alcohol. In yet a further embodiment, the modified polyvinyl alcohol is crosslinked.

In an embodiment, the topcoat comprises a polyvinyl alcohol. The polyvinyl alcohol of the top coat may be the same polyvinyl alcohol as the oxygen barrier layer.

In embodiments, the oxygen barrier layer has a thickness greater than or equal to 1.0 μm.

In embodiments, the recording medium has a print quality. A print quality of the recording medium, when printed with a thermal printer energy setting of 15 mJ/mm² heat and 3 ips on a Zebra 140XI4, is characterized by an ANSI value of at least 3. In another embodiment, a print quality of the recording medium, when printed with a thermal printer energy setting of 15 mJ/mm² heat and 3 ips on a Zebra 140XI4, is characterized by an ANSI value of at least 1.5 after the printed recording medium is placed in a Q-sun Xenon test chamber model Xe-3-H at a temperature of 55° C. with lamps at an irradiance of 0.68 w/m² for 200 hours.

### DETAILED DESCRIPTION

Unless stated to the contrary, implicit from context, or customary in the art, all parts and percents are based on volume. The terms “comprising,” “including,” “having” and their derivatives are not intended to exclude the presence of any additional component, step or procedure, whether or not the same is specifically disclosed. In order to avoid any doubt, all compositions claimed through use of the term “comprising” may include any additional additive, adjuvant, or compound unless stated to the contrary. In contrast, the term “consisting essentially of” excludes from the scope of any succeeding recitation any other component, step or procedure, excepting those that are not essential to operability. The term “consisting of” excludes any component, step or procedure not specifically delineated or listed.

The term “direct contact” as used herein with reference to layers refers to two layers that are immediately adjacent one another with no intervening layers.

The term “facial surface” as used herein with reference to layers refers to the surfaces of the layers that are in contact with the opposite and adjacent surfaces of the adjoining layers. Facial surfaces are in distinction to edge surfaces. A rectangular film or layer comprises two facial surfaces and four edge surfaces. A circular layer comprises two facial surfaces and one continuous edge surface.

The numerical ranges in this disclosure include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 5; 1 to 6; 1 to 7; 2 to 5; 2 to 6; 2 to 7; 3 to 5; 3 to 6; 3 to 7; etc.).

In embodiments of the present disclosure, a recording medium is provided. The recording medium comprises an imaging layer having a first facial surface and a second facial surface, and an oxygen barrier layer having a first facial surface and a second facial surface. The first facial surface of the oxygen barrier layer is in direct contact with the second facial surface of the imaging layer. The oxygen barrier layer comprises a polyvinyl alcohol.

### Oxygen Barrier Layer

The oxygen barrier layer comprises a polyvinyl alcohol. Polyvinyl alcohol (PVA or PVOH) is a polymer having the idealized formula [CH₂CH(OH)]ₙ. PVA may be functionalized, such as, for example, to introduce crosslinking functionality.

In an embodiment, the PVA used in the oxygen barrier layer has a viscosity greater than 10 cP, or greater than 15 cP, or greater than or equal to 20 cP. In an embodiment, the PVA used in the oxygen barrier layer has a viscosity from greater than or equal to 20 cP to 120 cP, or 130 cP, or 140 cP.

In an embodiment, the PVA used in the oxygen barrier layer has a molecular weight from 85,000 Da to 320,000 Da.

In an embodiment, the PVA used in the oxygen barrier layer has a molecular weight from 85,000 to 320,000 and a viscosity from greater than or equal to 20 cP to 120 cP.

One of skill in the art will readily appreciate the relationship between molecular weight and viscosity and understand PVAs of higher viscosity generally have higher molecular weights.

In an embodiment, the PVA is a functionalized PVA. The PVA may be a carboxylated PVA.

Exemplary PVAs which may be used in the oxygen barrier layer include, but are not limited to, Kuraray Poval™ 100-88 (having a viscosity of 100 cP, a degree of hydrolysis of 88 mol %, a non-volatile content of 97.5±2.5 wt %, an ash content of ≤0.4 wt %, and a pH of 5.0-7.0), Kuraray Poval™ 25-88 KL (having a viscosity of 25 cP, a degree of hydrolysis of 88 mol %, a non-volatile content of 97.5-2.5 wt %, an ash content of ≤1.5 wt %, and a pH of 5.0-7.0), Gohsenx™ T-350 (having a viscosity of 30 cP, a degree of hydrolysis of 94 mol %, and a pH of 6.5-7.5), Selvol™ 125 (having a viscosity of 30 cP and a degree of hydrolysis of 99.65 mol %), GH-17R (having a viscosity of 30 cP and a degree of hydrolysis of 87.75), and Selvol™ 165 (having a viscosity of 67 cP and a degree of hydrolysis of 99.65).

The oxygen barrier layer comprises greater than or equal to 30 wt % PVA, or from greater than 30 wt % to 100 wt % PVA. In an embodiment, the oxygen barrier layer comprises from greater than 30 wt %, or greater than 35 wt %, or greater than 40 wt %, or greater than 45 wt %, or greater than 50 wt %, or greater than 55 wt %, or greater than 60 wt %, or greater than 65 wt % to 70 wt %, or 75 wt %, or 80 wt %, or 85 wt %, or 90 wt %, or 95 wt %, or 100 wt %. In a particular embodiment, the oxygen barrier layer comprises from greater than or equal to 60 wt %, or from greater than or equal to 65 wt %, or from greater than or equal to 70 wt % to less than or equal to 85 wt %, or to less than or equal to 90 wt %, or to less than or equal to 95 wt %, or to less than or equal to 100 wt %.

In an embodiment, the oxygen barrier layer further comprises a crosslinking resin. Suitable crosslinking resins are based on epichlorohydrin and/or include an azetidintum functional group. Exemplary crosslinking resins include, but are not limited to, Polycup™ 172, Polycup™ 2000, Plycup™ 8210, and Polycup™ 9200, each of which are available from Solenis LLC, epichlorohydrin-based, and include an azetidintum functional group.

The total PVA and crosslinking resin in the oxygen barrier layer is from greater than 30 wt % to 100 wt %. In embodiments, the total PVA and crosslinking resin in the oxygen barrier layer is from greater than 30 wt %, or 35 wt %, or 40 wt %, or 45 wt %, or 50 wt %, or 55 wt % to 60 wt %, or 65 wt %, or 70 wt %, or 75 wt %, or 80 wt %, or 85 wt %, or 90 wt %, or 95 wt %, or 100 wt %. In a particular embodiment, the total PVA and crosslinking resin in the oxygen barrier layer is from greater than or equal to 60 wt % to 100 wt %. In an embodiment, the total PVA and crosslinking resin in the oxygen barrier is from greater than or equal to 60 wt %, or greater than or equal to 65 wt %, or greater than or equal to 70 wt % to less than or equal to 80 wt %, or 90 wt %, or less than or equal to 100 wt %.

In an embodiment, the oxygen barrier layer includes a pigment, such as a delaminated clay. When an oxygen barrier layer includes a pigment, the pigment is present in an amount from greater than or equal to 20 wt %, or greater than or equal to 25 wt %, or greater than or equal to 30 wt %, or greater than or equal to 35 wt %, or greater than or equal to 40 wt % to 50 wt %, or 55 wt %, or 60 wt %, or 65 wt %.

In embodiments in which the oxygen barrier layer includes a pigment, such as delaminated clay, the PVA is present in the oxygen barrier layer in an amount from greater than or equal to 30 wt %, or greater than or equal to 35 wt %, or greater than or equal to 40 wt % to 50 wt %, or 55 wt %, or 60 wt %, or 65 wt %. In embodiments in which the oxygen barrier layer includes a pigment, such as delaminated clay, and a crosslinking resin, the total PVA and crosslinking resin in the oxygen barrier layer is from greater than or equal to 30 wt %, or 35 wt %, or 40 wt %, or 45 wt %, or 50 wt %, or 55 wt % to 60 wt %, or 65 wt %, or 70 wt %, or 75 wt %.

### Imaging Layer

The imaging layer provides the print functionality. In an embodiment, the imaging layer comprises a combination of a leuco dye or other chromogenic material and a developer. The dye and developer are dispersed substantially uniformly throughout the imaging layer in a solid matrix or binder. In an embodiment, the imaging layer is a thermally responsive layer comprising a leuco dye and at least one developer. Leuco dyes are generally not phenol-based, and the selection of the leuco dye does not substantially affect the function of the oxygen barrier layer. The at least one developer may be selected from (N-[2-(3-phenyl-lureido)phenyl]benzenesulfonamide) (tradename NKK-1304 sold by Nippon Soda Co. Ltd.), TGMD (sold by Nippon Kayaku Co. Ltd.), S-176 (sold by Sanko Co. Ltd.), urea urethane and urea urethane dispersions such as Urea Urethane Compound sold by Chemipro Kasei Kaisha Ltd. and identified by CAS No. 321860-75-7, 1,3-diphenyl urea (DPU), 4-hydroxyphenyl-4-isopropoxyphenylsulfone (tradename D-8), 4-hydroxyphenol sulfone (tradename BPS), 4-benzyloxyphenyl-4′-hydroxyphenol sulfone (tradename BPS-MBE), 2,2′-diallyl-4,4′ sulfonyldiphenol (tradename TGSH), and combinations thereof.

Imaging layers may include additional components which are known in the art and do not substantially alter the function of the imaging layer. Such additives include binders, such as low molecular weight and low viscosity polyvinyl alcohols in solution with water, defoaming agents, dispersing agents, and the like.

### Topcoat Layer

In an embodiment, the recording medium comprises a topcoat layer. Topcoat layers are known in the art and do substantially change the function of the oxygen barrier layer. Exemplary topcoats for use with an oxygen barrier layer as describe herein include, but are not limited to, topcoats composed of aluminum hydroxide, binder, zinc, and a crosslinker.

In an embodiment, the topcoat comprises a PVA binder. The PVA may be in accordance with any embodiment or combination of embodiments described herein with reference to the oxygen barrier layer. In a further embodiment, the topcoat may have the same composition as an oxygen barrier layer in accordance with any embodiment or combination or embodiments described herein. In some embodiments, the PVA of the topcoat binder is the same PVA as that in the oxygen barrier layer. In still further embodiments, the PVA in the topcoat binder may be a different PVA than that of the oxygen barrier layer, while still in accordance with PVA described in reference to the oxygen barrier layer.

In a further embodiment, the PVA of the topcoat binder may be one not suitable for use in the oxygen barrier layer, such as, and not limited to, a low molecular weight, low viscosity PVA.

### Recording Medium

In an embodiment, the recording medium comprises an imaging layer and an oxygen barrier layer. The imaging layer and oxygen barrier layer may be according to any embodiment or combination of embodiments provided herein.

The imaging layer has a first facial surface and a second facial surface. The oxygen barrier layer also has a first facial surface and a second facial surface. The first facial surface of the oxygen barrier layer is in direct contact with the second facial surface of the imaging layer.

In an embodiment, the oxygen barrier layer has a thickness of greater than or equal to 0.5 μm, or greater than or equal to 1 μm, or greater than or equal to 1.25 μm. In an embodiment, the oxygen barrier layer has a thickness from greater than or equal to 0.5 μm, or greater than or equal to 1 μm, or greater than or equal to 1.25 μm, or greater than or equal to 1.5 μm to less than or equal to 1.75 μm, or less than or equal to 2 μm, or less than or equal to 2.25 μm, or less then or equal to 2.5 μm.

In an embodiment, the imaging layer has an application rate of 1 g/m² to 3 g/m².

In an embodiment, the recording medium comprises a topcoat. The topcoat has a first facial surface and a second facial surface. The second facial surface of the topcoat may be in direct or indirect contact with the first facial surface of the imaging layer.

In an embodiment, the recording medium is a direct thermal recording medium.

Recording media, and particularly direct thermal recording media, are used in a variety of settings and, as such, can be exposed to a wide variety of environmental agents, contaminants, and conditions. Images formed by direct thermal printing on such materials are known to be prone to degradation when exposed to light and heat typically found in outdoor environments but may not be found in indoor environments, such as against south facing windows.

In an embodiment, a recording medium in accordance with any embodiment or combination of embodiments disclosed herein is designed to withstand exposure to sunlight. In some embodiments, the recording medium is used to print barcode. The quality (readability) of a barcode is measured using standards set forth by the American National Standards Institute (ANSI). A barcode is assessed on eight different characteristics and assigned a number on a scale of 0 to 4, with 4 being the best quality.

In an embodiment, a print quality of a recording medium according to any embodiment or combination of embodiments described herein, when printed with a thermal printer energy setting of 15 mJ/mm² heat and 3 inches per second (ips) on a Zebra 140XI4 is characterized by an initial ANSI value of at least 3, or at least 3.1, or at least 3.2, or at least 3.3, or at least 3.4, or at least 3.5, or at least 3.6.

In an embodiment, a print quality of a recording medium according to any embodiment or combination of embodiments described herein, when printed with a thermal printer energy setting of 15 mJ/mm² heat and 3 ips on a Zebra 140XI4 is characterized by an ANSI value of at least 1.5, or at least 2.0, or at least 2.5, or at least 3.0 after the printed recording medium is placed in a Q-sun Xenon test chamber model Xe-3-H. Lamps were set to an irradiance of 0.68 w/m². Black panel temperature was set to 55° C. and a chamber air was set to 35° C. In an embodiment, the printed sample is taped onto the inside panel of a Q-sun and exposed for 200 hours. At the end of the test samples are removed and scanned. This ANSI value is referred to as a “final ANSI value.”

In an embodiment, a recording medium has a percent ANSI retention as calculated by dividing the final ANSI value by the initial ANSI value and multiplying the result by 100. In an embodiment, the percent ANSI retention is greater than or equal to 50%, or 55%, or 60%, or 65%, or 70%, or 75%, or 80%. In a particular embodiment, the percent ANSI retention is greater than 70%, or greater than 75%, or greater than 80%, or greater than 85%.

Recording media according to the present disclosure have an image intensity. The image intensity is measured using a Techkon Spectrodens Densitometer. Initial image intensity is measured after printing with a thermal printer energy setting of 15 mJ/mm² heat and 3 inches per second (ips) on a Zebra 140XI4. Final image intensity is measured after the printed recording medium is placed in a Q-sun Xenon test chamber model Xe-3-H. Lamps were set to an irradiance of 0.68 w/m². Back panel temperature was set to 55° C. and a chamber air was set to 35° C. In an embodiment, the printed sample is taped onto the inside panel of a Q-sun and exposed for 200 hours.

In an embodiment, a recording medium has an initial image intensity greater than or equal to 2, or 2.02, or 2.04, or 2.06 to 2.08, or 2.10, or 2.12. In an embodiment, a recording medium has a final image intensity greater than or equal to 1.75, or 1.80, or 1.85 to 1.90, or 1.96, or 2.0. In an embodiment, the image retention, as calculated by dividing the final image intensity by the initial image intensity and multiplying it by 100, is from greater than or equal to 85%, or greater than or equal to 86%, or greater than or equal to 87%, or greater than or equal to 88%, or greater than or equal to 89%, or greater than or equal to 90% to 91%, or 92%, or 94%, or 96%, or 98%, or less than 100%.

### Experimental Data

Examples using the materials, compositions, and structures below were imaged using a barcode at a print speed of 3 ips on the 15 mJ/mm² setting on a Zebra 140-4XI printer. Both a UPCA barcode and a solid block were imaged. Image loss was measured using a Techkon Spectrodens Densitometer. The initial image and the image after testing were recorded. The delta of the values was divided by the initial to give a percent. The barcode quality (ANSI value) was tested using a TruCheck TC-843 verifier at 650 nm and calibrated to ANSI Bar Code Print Quality Guideline, X3.182, published in 1990.

### Oxygen Barrier Layer Materials

TABLE 1
Polyvinyl Alcohols (PVAs) Used in Examples

| | Commercial | Viscosity @ | % | |
|---|---|---|---|---|
| | Information | 4% in c.p. | Hydrolysis | Functionality |
| PVA 1 | Selvol ™ 103 | 4 | 98.4 | |
| | Sekisui Specialty | | | |
| | Chemicals | | | |
| | America, LLC | | | |
| PVA 2 | 4 88 | 4 | 88 | |
| | Kuraray Co., Ltd. | | | |
| PVA 3 | 25 88 KL | 25 | 88 | Carboxyl- |
| | Kuraray Co., Ltd. | | | functionalized |
| PVA 4 | Selvol ™ 125 | 30 | 99.65 | |
| | Sekisui Specialty | | | |
| | Chemicals | | | |
| | America, LLC | | | |
| PVA 5 | T-350 | 30 | 94 | Carboxyl- |
| | Mitsubishi Chemical | | | functionalized |
| | Group Corporation | | | |
| PVA 6 | GH-17R | 30 | 87.75 | |
| | Mitsubishi Chemical | | | |
| | Group Corporation | | | |
| PVA 7 | Selvol ™ 165 | 67 | 99.65 | |
| | Sekisui Specialty | | | |
| | Chemicals | | | |
| | America, LLC | | | |
| PVA 8 | 100 88 | 100 | 88 | |
| | Kuraray Co., Ltd. | | | |

Crosslinker: POLYCUP 172, 12.5% solids
Clay: Delaminated clay dispersion @ 30% solids in water

The above PVAs were used in four different coating compositions as described below.

### Oxygen Barrier Coating Formulation 1 (OBCF 1):

| | | |
|---|---|---|
| Parts by | Parts by | |
| Weight | Weight | |
| (wet) | (dry) | Dry wt % |

Oxygen Barrier Coating Formulation 1 (OBCF 1):

| | | | |
|---|---|---|---|
| PVA, 8% solution | 100 | 8 | 100 wt % |
| in water | | | |

OBCF 2:

| | | | |
|---|---|---|---|
| PVA, 8% solution | 83.5 | 6.68 | 83.2 wt % |
| in water | | | |
| Crosslinker | 10.8 | 1.35 | 16.8 wt % |
| Water | 5.7 | 0 | 0 |

OBCF 3:

| | | | |
|---|---|---|---|
| PVA, 8% solution | 61.4 | 4.912 | 61.3 wt % |
| in water | | | |
| Clay | 7.0 | 2.1 | 26.2 wt % |
| Crosslinker | 8.0 | 1 | 12.5 wt % |
| Water | 23.6 | 0 | 0 |

OBCF 4:

| | | | |
|---|---|---|---|
| PVA, 8% solution | 37.1 | 2.968 | 36.9 wt % |
| in water | | | |
| Clay | 14.9 | 4.47 | 55.6 wt % |
| Crosslinker | 4.8 | 0.6 | 7.5 wt % |
| Water | 43.2 | 0 | 0 |

### Imaging Layer Materials

ODB-2: 2′-anilino-6′-(dibutylamino)-3′-methylspiro[2-benzofuran-3,9′-xanthene]-1-one (CAS No. 89331-94-2)

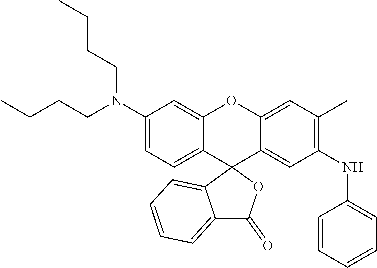 [SMILES: CCCCN(CCCC)c1ccc2c(c1)Oc1cc(C)c(Nc3ccccc3)cc1C21OC(=O)c2ccccc21]

ETAC: 22′-anilino-6′-(N-ethyl-4-methylanilino)-3′-methylspiro[2-benzofuran-3,9′-xanthene]-1-one (CAS No. 59129-79-2)

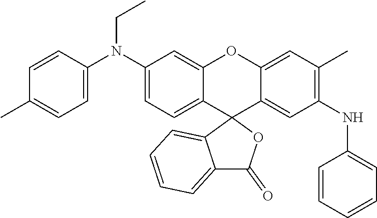 [SMILES: CCN(c1ccc(C)cc1)c1ccc2c(c1)Oc1cc(C)c(Nc3ccccc3)cc1C21OC(=O)c2ccccc21]

TGSH: 4-(4-hydroxy-3-prop-2-enylphenyl) sulfonyl-2-prop-2-enylphenol (CAS No. 41481-66-7)

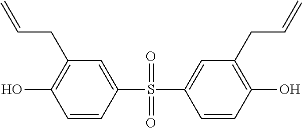 [SMILES: C=CCc1cc(S(=O)(=O)c2ccc(O)c(CC=C)c2)ccc1O]

TGMD: a compound having the structure below and identified by CAS No. 2102522-55-2:

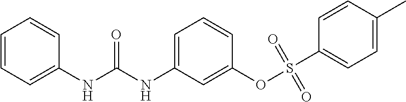 [SMILES: Cc1ccc(S(=O)(=O)Oc2cccc(NC(=O)Nc3ccccc3)c2)cc1]

S-176: a compound having the structure below and identified by CAS No. 2292123-68-1:

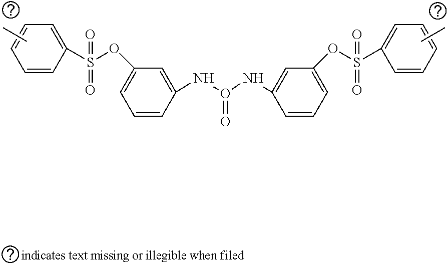

wherein each Rₙ is independently a C₁₋₇ alkyl group.
Binder 1: 20% solution of PVA in water
Binder 2: 10% solution of PVA in water
Additives: defoaming and dispersing agents

The above materials were used in the chromogenic dispersion and developer dispersion as described below:

### Chromogenic Dispersion:

| | |
|---|---|
| Chromogenic Material: | 30.0 parts |
| Binder 1 | 25.0 parts |
| Additives | 0.4 parts |
| Water | 44.6 parts |

### Developer Dispersion:

| | |
|---|---|
| Developer Material | 38.0 parts |
| Binder 1 | 18.0 parts |
| Additives | 0.4 parts |
| Water | 43.6 parts |

The imaging layer coating formulations (ILCF) used in the examples have the following compositions:

| | Chromogenic | Chromogenic | Developer | Developer | Binder | Filler Slurry |
|---|---|---|---|---|---|---|
| | Dispersion | Material | Composition | Material | 2 | (30% in water) |
| ILCF 1 | 22.0 parts | ETAC | 38.0 parts | TGSH | 25.0 parts | 15.0 parts |
| ILCF 2 | 22.0 parts | ODB-2 | 38.0 parts | S-176 | 25.0 parts | 15.0 parts |
| | | | | (50%) | | |
| | | | | TGMD | | |
| | | | | (50%) | | |

The imaging layer was applied to all examples at 2.5 gsm.

### Topcoat

Each example included a topcoat having the formulation below. The topcoat was applied at 3 gsm.

### Topcoat Formulation:

| | |
|---|---|
| Slurry, 30% aluminum hydroxide in water | 23.0 parts |
| Binder (aqueous solution of PVA (10%)) | 63.0 parts |
| Zinc (44% in water) | 1.0 parts |
| Crosslinker | 13.0 parts |

Various sample structures (imaging layer/oxygen barrier layer/topcoat) were created using the different formulations described herein and tested for initial and final ANSI values and percent image retention. The results are shown in Table 2, below.

TABLE 2
ANSI Values and Image Intensity of Recording Media

| | | | | Oxygen | | | | | | | |
|---|---|---|---|---|---|---|---|---|---|---|---|
| | | PVA in | Oxygen | Barrier | Imaging | | | | | | |
| | | Oxygen | Barrier | Layer | Layer | ANSI | | | Image Intensity | | |
| | | Barrier | Coating | Thickness | Coating | | | % | | | % |
| | Example | Layer | Formulation | (μm) | Formulation | Initial | Final | Retention | Initial | Final | Retention |
| Carboxylate, | 1 | PVA 5 | OBCF 1 | 2 | ILCF 1 | 3.7 | 3.1 | 84 | 2.08 | 2.02 | 97 |
| Viscosity | 2 | PVA 5 | OBCF 2 | 2 | ILCF 1 | 3.8 | 3.3 | 87 | 2.08 | 2.00 | 96 |
| 30 cP | 3 | PVA 5 | OBCF 3 | 2 | ILCF 1 | 3.9 | 3.4 | 87 | 2.09 | 1.94 | 93 |
| | 4 | PVA 5 | OBCF 4 | 2 | ILCF 1 | 3.8 | 3.1 | 82 | 2.07 | 1.75 | 85 |
| | 5 | PVA 5 | OBCF 1 | 1 | ILCF 1 | 4.0 | 3.5 | 88 | 2.12 | 2.01 | 95 |
| | 6 | PVA 5 | OBCF 2 | 1 | ILCF 1 | 4.0 | 3.7 | 93 | 2.10 | 2.00 | 95 |
| | Comp. 1 | PVA 5 | OBCF 1 | 2 | ILCF 2 | 4.0 | 2.8 | 70 | 1.95 | 1.81 | 93 |
| Carboxylated, | 7 | PVA 3 | OBCF 1 | 2 | ILCF 1 | 3.8 | 3.1 | 82 | 2.07 | 1.90 | 92 |
| Viscosity | 8 | PVA 3 | OBCF 2 | 2 | ILCF 1 | 4.0 | 3.2 | 80 | 2.09 | 1.94 | 93 |
| 25 cP | 9 | PVA 3 | OBCF 1 | 1 | ILCF 1 | 4.0 | 3.4 | 85 | 2.12 | 1.91 | 90 |
| | 10 | PVA 3 | OBCF 2 | 1 | ILCF 1 | 4.0 | 3.2 | 80 | 2.1 | 1.89 | 90 |
| Viscosity | 11 | PVA 8 | OBCF 1 | 2 | ILCF 1 | 3.7 | 2.8 | 76 | 2.08 | 1.85 | 89 |
| 100 cP | 12 | PVA 8 | OBCF 2 | 2 | ILCF 1 | 4.0 | 3.2 | 80 | 2.06 | 1.81 | 88 |
| | 13 | PVA 8 | OBCF 1 | 1 | ILCF 1 | 4.0 | 3 | 75 | 2.1 | 1.81 | 86 |
| | 14 | PVA 8 | OBCF 2 | 1 | ILCF 1 | 3.9 | 3.1 | 79 | 2.07 | 1.80 | 87 |
| Viscosity | 15 | PVA 7 | OBCF 1 | 2 | ILCF 1 | 3.7 | 3.3 | 89 | 2.08 | 1.87 | 90 |
| 67 cP | 16 | PVA 7 | OBCF 2 | 2 | ILCF 1 | 3.8 | 3.4 | 89 | 2.1 | 1.93 | 92 |
| | 17 | PVA 7 | OBCF 1 | 1 | ILCF 1 | 4.0 | 3.1 | 78 | 2.11 | 1.92 | 91 |
| | 18 | PVA 7 | OBCF 2 | 1 | ILCF 1 | 4.0 | 3.2 | 80 | 2.09 | 1.88 | 90 |
| | Comp. 2 | PVA 7 | OBCF 2 | 2 | ILCF 2 | 4.0 | 2.4 | 60 | 1.97 | 1.71 | 87 |
| Viscosity | 19 | PVA 6 | OBCF 1 | 2 | ILCF 1 | 3.6 | 2.7 | 75 | 2.07 | 1.86 | 90 |
| 30 cP | 20 | PVA 6 | OBCF 2 | 2 | ILCF 1 | 3.6 | 3 | 83 | 2.06 | 1.83 | 89 |
| | 21 | PVA 6 | OBCF 1 | 1 | ILCF 1 | 3.8 | 1.9 | 50 | 2.09 | 1.79 | 86 |
| | 22 | PVA 6 | OBCF 2 | 1 | ILCF 1 | 3.8 | 2 | 53 | 2.1 | 1.81 | 86 |
| Viscosity | 23 | PVA 4 | OBCF 1 | 2 | ILCF 1 | 3.7 | 3.2 | 86 | 2.1 | 1.97 | 94 |
| 30 cP | 24 | PVA 4 | OBCF 2 | 2 | ILCF 1 | 3.8 | 3.3 | 87 | 2.1 | 2.00 | 95 |
| | 25 | PVA 4 | OBCF 1 | 1 | ILCF 1 | 4.0 | 2.8 | 70 | 2.07 | 1.90 | 92 |
| | 26 | PVA 4 | OBCF 2 | 1 | ILCF 1 | 4.0 | 2.6 | 65 | 2.11 | 1.92 | 91 |
| Viscosity | Comp. 3 | PVA 2 | OBCF 1 | 2 | ILCF 1 | 3.5 | 0 | 0 | 2.01 | 0.46 | 23 |
| 4 cP | Comp. 4 | PVA 2 | OBCF 2 | 2 | ILCF 1 | 3.7 | 0 | 0 | 2.07 | 0.52 | 25 |
| | Comp. 5 | PVA 2 | OBCF 1 | 1 | ILCF 1 | 3.8 | 0 | 0 | 2 | 0.42 | 21 |
| | Comp. 6 | PVA 2 | OBCF 2 | 1 | ILCF 1 | 3.8 | 0 | 0 | 2.02 | 0.40 | 20 |
| Viscosity | Comp. 7 | PVA 1 | OBCF 1 | 2 | ILCF 1 | 3.7 | 0 | 0 | 2.02 | 0.53 | 26 |
| 4 cP | Comp. 8 | PVA 1 | OBCF 2 | 2 | ILCF 1 | 3.8 | 0 | 0 | 2.07 | 0.58 | 28 |
| | Comp. 9 | PVA 1 | OBCF 1 | 1 | ILCF 1 | 3.7 | 0 | 0 | 2.08 | 0.50 | 24 |
| | Comp. 10 | PVA 1 | OBCF 2 | 1 | ILCF 1 | 3.9 | 0 | 0 | 2.05 | 0.43 | 21 |
| | Comp. 11 | PVA 1 | OBCF 1 | 2 | ILCF 2 | 3.8 | 0 | 0 | 1.95 | 0.36 | 18 |
| | Control 1 | n/a | n/a | 0 | ILCF 1 | 4.0 | 0 | 0 | 2.09 | 0.38 | 18 |
| | Control 2 | n/a | n/a | 0 | ILCF 2 | 4 | 0 | 0 | 2.02 | 0.30 | 15 |

As illustrated in Table 2, recording media having an oxygen barrier layer containing a PVA with a higher viscosity (and therefore a higher molecular weight) show improved final ANSI values, greater ANSI retention, and greater image intensity retention than recording media having an oxygen barrier layer containing a PVA with a lower viscosity (and therefore a lower molecular weight). In particular, the comparative examples 3-11 each use a PVA having a viscosity of 4 cP and have a final ANSI value of 0 with an image intensity retention of less than 30%. In contrast, the inventive examples each use a PVA having a viscosity of 25 cP to 100 cP and have final ANSI values consistently over the minimum passable value of 1.5, and indeed most having a final ANSI value greater than 2. Similarly, the image intensity retentions of examples 1-26 are well above 80%, while the comparative examples 3-11 have image intensity retentions of below 30%.

Examples 1-4 further illustrate the effect of pigment, and particularly delaminated clay, in the oxygen barrier layer. As shown by Examples 3 and 4, the amount of PVA required in the oxygen barrier layer to show improved ANSI and image intensity retention is significantly less when the delaminated clay is included.

From the foregoing, it will be appreciated that although specific embodiments or examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

It is specifically intended that the present invention not be limited to the embodiments, examples and illustrations contained herein, but include modified forms of those embodiments or examples including portions of the embodiments or examples and combinations of elements of different embodiments or examples as come within the scope of the following claims.

What is claimed is:

1. A recording medium, comprising:
an imaging layer having a first facial surface and a second facial surface;
an oxygen barrier layer having a first facial surface and a second facial surface; and
a topcoat layer in direct or indirect contact with the first facial surface of the imaging layer;
wherein the first facial surface of the oxygen barrier layer is in direct contact with the second facial surface of the imaging layer; and
wherein the oxygen barrier layer comprises a polyvinyl alcohol.

2. The recording medium of claim 1, wherein the oxygen barrier layer comprises from greater than or equal to 30 wt % to less than or equal to 100 wt % of the polyvinyl alcohol.

3. The recording medium of claim 2, wherein the oxygen barrier layer comprises from greater than or equal to 60 wt % to less than or equal to 95 wt % of the polyvinyl alcohol.

4. The recording medium of claim 2, wherein the oxygen barrier layer comprises from greater than or equal to 30 wt % to less than or equal to 75 wt % of the polyvinyl alcohol.

5. The recording medium claim 1, wherein the polyvinyl alcohol has a viscosity greater than 10 cP.

6. The recording medium of claim 1, wherein the polyvinyl alcohol has a viscosity from greater than or equal to 20 cP to 140 cP.

7. The recording medium of claim 1, wherein the polyvinyl alcohol has a molecular weight from 85,000 Da to 320,000 Da.

8. The recording medium of claim 7, wherein the polyvinyl alcohol has a viscosity from greater than or equal to 20 cP to 140 cP.

9. The recording medium of claim 1, wherein the polyvinyl alcohol is a modified polyvinyl alcohol.

10. The recording medium of claim 9, wherein the modified polyvinyl alcohol is a carboxylated polyvinyl alcohol.

11. The recording medium of claim 10, wherein the modified polyvinyl alcohol is crosslinked.

12. The recording medium of claim 1, wherein the topcoat comprises a polyvinyl alcohol.

13. The recording medium of claim 12, wherein the polyvinyl alcohol of the topcoat is the same as the polyvinyl alcohol of the oxygen barrier layer.

14. The recording medium of claim 1, wherein the oxygen barrier layer has a thickness greater than or equal to 1.0 μm.

15. The recording medium of claim 1, wherein a print quality of the recording medium, when printed with a thermal printer energy setting of 15 mJ/mm² heat and 3 ips on a Zebra 140XI4, is characterized by an ANSI value of at least 3.

16. The recording medium of claim 1, wherein a print quality of the recording medium, when printed with a thermal printer energy setting of 15 mJ/mm² heat and 3 ips on a Zebra 140XI4, is characterized by an ANSI value of at least 1.5 after the printed recording medium is placed in a Q-sun Xenon test chamber model Xe-3-H at a temperature of 55° C. with lamps at an irradiance of 0.68 w/m² for 200 hours.

17. The recording medium of claim 15, wherein a print quality of the recording medium, when printed with a thermal printer energy setting of 15 mJ/mm² heat and 3 ips on a Zebra 140XI4, is characterized by an ANSI value of at least 1.5 after the printed recording medium is placed in a Q-sun Xenon test chamber model Xe-3-H at a temperature of 55° C. with lamps at an irradiance of 0.68 w/m² for 200 hours.

18. The recording medium of claim 15, wherein a print quality of the recording medium, when printed with a thermal printer energy setting of 15 mJ/mm² heat and 3 ips on a Zebra 140XI4, is characterized by an image retention of greater than or equal to 85% after the printed recording medium is placed in a Q-sun Xenon test chamber model Xe-3-H at a temperature of 55° C. with lamps at an irradiance of 0.68 w/m² for 200 hours.

19. The recording medium of claim 15, wherein a print quality of the recording medium, when printed with a thermal printer energy setting of 15 mJ/mm² heat and 3 ips on a Zebra 140XI4, is characterized by an ANSI retention of greater than or equal to 50% after the printed recording medium is placed in a Q-sun Xenon test chamber model Xe-3-H at a temperature of 55° C. with lamps at an irradiance of 0.68 w/m² for 200 hours.

20. The recording medium of claim 1, wherein the recording medium is a direct thermal recording medium.
